(19) United States
(12) Patent Application Publication
(10) Pub. No.: US 2019/0357712 A1
(43) Pub. Date: Nov. 28, 2019

(54) DISPENSING DEVICE FOR A TWO-PART DISPENSING UNIT

(71) Applicant: NORDIC BULK SOLUTIONS ApS, Bogø By (DK)

(72) Inventors: Christian Bhishma Jespersen, Langebæk (DK); Ole Bjørn Jespersen, Langebæk (DK)

(73) Assignee: NORDIC BULK SOLUTIONS ApS, Bogø By (DK)

(21) Appl. No.: 16/477,425

(22) PCT Filed: Jan. 5, 2018
(86) PCT No.: PCT/DK2018/050002

§ 371 Date: Jul. 11, 2019

(30) Foreign Application Priority Data
Jan. 12, 2017 (DK) PA 2017 00028

(51) Int. Cl. A47G 19/34; A47F 1/03; G07F 11/44

(52) U.S. Cl. CPC A47G 19/34; G07F 11/44; A47F 1/03

(57) ABSTRACT

A dispensing device (2) for a two-part dispensing unit (1) for dispensing foodstuff, said dispensing device (2) comprising a funnel (5) with a first opening (701) adapted to face the container portion (3) and a second opening (702) adapted to dispense the foodstuff, a forwarding device (15) adapted to lead the amount of foodstuff from the first opening (701) to the second opening (702), and a handle (27) connected to the forwarding device (15) and adapted to activate the forwarding device (15), wherein the handle (27) is connected to the forwarding device (15) such that the forwarding device (15) is only activated when the handle (27) is moved in a first activation direction (A) and is not activated when the handle (27) is moved in an opposite reset direction (R).

The present invention relates to a dispensing device for dispensing foodstuff, a dispensing unit comprising such a dispensing device, use of said dispensing device to dispense foodstuff, and a method for refilling a dispensing unit.

### BACKGROUND OF THE INVENTION

Discarded packaging materials used to package foodstuff consumed in modern day households leads to substantial costs in the modern day society. Not only does the waste from such material place an immense cost for maintaining infrastructure and disposal, the packaging material also accumulates in the environment due to the slow decomposition rate, where it causes considerable damage to the ecosystem.

To reduce the amount of material needed, some grocery stores have returned to purchase unpackaged foodstuff in bulk, whereby the consumers may transfer the unpackaged foodstuff from containers or dispensers in the store to reusable containers which they can bring home.

While such sales methods save substantial amounts of package material, thereby reducing the amount of waste produced, the dispensers holding the foodstuff currently used in many stores are of the open type where the consumer uses either a disposable glove, scoop, or shovel to transfer food-stuff from the dispenser/container to a reusable container or a bag.

Furthermore, the container or dispenser are often refilled in the store with foodstuff delivered to the store in large containers. While such containers produce less waste than the package material used to package single portions of foodstuff, it still produces an unnecessary amount of waste. Additionally, the hygiene is compromised by transferring foodstuff from the delivery container to a dispenser or open container in the store.

Dispensing units such as the one described in the applicant's US 2004/0222232 A1 overcome these issues by providing a two-part dispensing unit with a container portion and a dispensing device adapted to, upon actuation, allow foodstuff to exit the dispensing unit via an exit opening. Such dispensing units are opened by uncovering the exit opening by pulling a lever, whereby foodstuff is passively dispensed continuously by means of gravity, and closed by covering the exit opening by resetting the lever.

While such dispensing units remove the need for the consumer to physically interact directly with the foodstuff, whereby dispensing is done in a much more hygienic manner, the method of dispensing by which the dispensing unit is opened until the lever is reset may lead to over-dispensing by the user. Furthermore, by dispensing the foodstuff passively by means of gravity through an exit opening, chunky and/or sticky foodstuffs may congregate to form a plug, whereby the exit opening becomes blocked.

On this background, it is an object of the invention to provide an improved dispensing unit which allows hygienic dispensing of the foodstuff without suffering from the drawbacks mentioned above.

### SUMMARY OF THE INVENTION

In a first aspect of the invention these objects and more are solved by dispensing device for a two-part dispensing unit for dispensing foodstuff, said dispensing device comprising a funnel with a first opening adapted to face a container portion of the two-part dispensing unit and a second opening adapted to dispense the foodstuff, a forwarding device adapted to lead an amount of foodstuff from the first opening to the second opening, and a handle connected to the forwarding device and adapted to activate the forwarding device, wherein the handle is connected to the forwarding device such that the forwarding device is only activated when the handle is moved in a first activation direction and is not activated when the handle is moved in an opposite reset direction.

By providing a dispensing device with a forwarding which leads foodstuff through the funnel, the foodstuff is actively led to the second opening whereas the dispensing units of the prior art relied solely on gravity to dispense out the foodstuff. Furthermore, the dispensing is made easier by providing a dispensing device in which the forwarding device does not need to be reset by the user.

In an embodiment, the dispensing device further comprises a one-way bearing which connects the handle to the forwarding device, whereby the forwarding device rotates when the handle is moved in the activation direction and remains still when the handle is moved in the reset direction.

The advantage of connecting the handle to the forwarding device by a one-way bearing is that the user is able to engage the forwarding device via the handle, while the one-way bearing will disconnect the handle and the forwarding device when the handle is moved in the reset direction.

In an embodiment of the invention, the dispensing unit further comprises a tensioning element which urges the handle towards the reset direction.

The advantage of providing a tensioning element is that the user does not need to perform the movement in the reset direction, as the tensioning element pulls or pushes the handle back into the initial position when the user releases the handle. In a presently preferred embodiment, the tensioning element is provided by a spring element which is fastened when the user moves the handle in the activation direction.

In an embodiment, the tensioning element is tensioned by movement of the handle in the activation direction. This not only allows the resetting of the handle to be easier, but the tensioning device will also provide a tactile feedback to the user.

In an embodiment, the tensioning element can be pre-tensioned to adjust the force by which the tensioning element urges the handle towards the reset direction. This allows the force required to activate the forwarding device to be adjusted according to a desired amount of tactile feedback and the density of the foodstuff to be dispensed.

In an embodiment, the forwarding device comprises a wheel with a number of equally sized cavities adapted to lead a predetermined amount of foodstuff from the first opening to the second opening. By providing the wheel of the forwarding device with a number of equally sized cavities adapted to lead the foodstuff to the second opening, the dispensing device of the invention may dispense a predetermined amount of foodstuff. The user may thereby avoid over-dispensing.

In an embodiment, the dispensing device further comprises a sealing element adapted to cover the first opening. By providing a sealing element for the dispensing device, the first opening if the funnel may be covered to enclose remaining foodstuff, after which the dispensing device can be flipped over onto a refilled or another full container portion and the sealing element removed.

In an embodiment, the funnel comprises two groves extending along respective sides of the first opening, said grooves being adapted to receive the sealing element. By providing two groves to receive the sealing element, the sealing element may be securely connected so that it does not unintentionally detach during refilling of the container portion.

In a second aspect of the invention the objects laid out in the background and more are solved by a two-part dispensing unit for dispensing foodstuff, said dispensing unit comprising, a container portion adapted to contain the foodstuff, and a dispensing device adapted to dispense an amount of the foodstuff from the container portion, wherein the dispensing device comprises, a funnel with a first opening adapted to face the container portion and a second opening adapted to dispense the foodstuff, a forwarding device adapted to lead the amount of foodstuff from the first opening to the second opening, and a handle connected to the forwarding device and adapted to activate the forwarding device, wherein the handle is connected to the forwarding device such that the forwarding device is only activated when the handle is moved in a first activation direction and is not activated when the handle is moved in an opposite reset direction.

The advantage of the two-part dispensing unit is that the user may dispense the foodstuff from the container portion without having physical contact with the foodstuff itself. This is made possible due to the forwarding device being activated via the handle which lets the user to operate the forwarding device and which can be brought back into an initial position by moving it in the reset direction without affecting the forwarding device. Through use of the dispensing unit of the invention an improvement of the foodstuff shelf life and traceability is achieved, while the amount of waste and risk of contagion is minimized. Furthermore, the invention may facilitate transport of the foodstuff, thus reducing transport cost and further reducing the impact on the environment.

In general, the dispensing device of the two-part dispensing unit of the second aspect may be according to the first aspect of the invention.

In a third aspect of the invention the objects laid out in the background and more are solved through use of the dispensing device according to the second aspect of the invention.

In a fourth aspect of the invention the objects laid out in the background and more are solved by a method for replacing or refilling a container portion of a two-part dispensing unit according to the second aspect of the invention, wherein the method comprises the steps of placing the two-part dispensing unit vertically with the dispensing device facing downwards; separating the container portion from the dispensing device; sealing the first opening of the dispensing device with a sealing element; refilling the container portion or replacing the container portion with another container portion; mounting the dispensing device on the refilled or the other container portion; and removing the sealing element from the dispensing device.

The two-part dispensing unit of the prior art was refilled by a similar method. The method of the invention differs in that the dispensing device is sealed to contain remaining foodstuff and then placed on the refilled or exchanged container, whereas the method disclosed in US 2004/0222232 A1 sealed the full container portion before placing it upside-down on the dispensing device. The advantage of the method of the invention, is that the grocer or worker replacing or refilling the container portion will only need to flip over the dispensing device with the enclosed remaining foodstuff instead of having to flip over a full container portion as in the prior art. The method of the invention therefore alleviates the lifting work for the store worker.

It should be noted that the term refilling as used in the context of this application, may also refer to replacing the container portion with another container portion.

### BRIEF DESCRIPTION OF THE DRAWINGS

The invention will be described in more detail below by means of non-limiting examples of embodiments and with reference to the schematic drawings, in which:

FIG. 1 shows a dispensing unit of the invention;

FIG. 2a-b shows a dispensing device of the dispensing unit of the invention;

FIG. 3 shows a container portion of the dispensing unit of the invention;

FIG. 4 shows the movement of the handle in the activation direction and the reset direction;

FIG. 5a-c show a funnel of the dispensing device;

FIG. 6 shows how a locking element may be connected to the funnel;

FIG. 7 shows how a spout may be placed on the funnel;

FIG. 8 shows how an amount control element may be placed in the spout;

FIG. 9a-c show how a container connection part is arranged in the funnel;

FIG. 10 shows how a lid is placed on the container portion;

FIG. 11 shows a sealing element and a lid;

FIG. 12 shows how the sealing element is placed in the funnel;

FIG. 13a-i show a rack adapted to hold and facilitate refilling of the dispensing unit of the invention, and the steps for a method for refilling the dispensing unit;

FIG. 14a-c show a tensioning element and a tensioning element holder of the forwarding device;

FIG. 15a-h show the assembly of the forwarding device;

FIG. 16a-b show an axle of the forwarding device;

FIG. 17 shows a wheel of the forwarding device;

FIG. 18 shows a one-way drive part of the forwarding device;

FIG. 19 shows an amount scoop of the forwarding device;

FIG. 20 shows a one-way drive part house of the forwarding device;

FIG. 21a-b show a one-way stopping element of the forwarding device;

FIG. 22 shows a tensioning element holder of the forwarding device;

FIG. 23a-b show a tensioning element of the forwarding device;

FIG. 24a-b show a spout of the dispensing device;

FIG. 25 shows a locking element;

FIG. 26a-d show various embodiments of a dispense rate control element;

FIG. 27a-c show a handle of the dispensing device;

FIG. 28 shows a container connection part;

FIG. 29 shows a rotating scoop element of the dispensing device;

FIG. 30 shows a lid for the container portion; and

FIG. 31 shows a sealing element.

### DETAILED DESCRIPTION OF THE INVENTION

In the following, embodiments of the invention will be described in further detail. Each specific variation of the features can be applied to other embodiments of the invention unless specifically stated otherwise.

FIG. 1 shows an embodiment of the dispensing unit 1 according to the invention, comprising a dispensing device 2 and a container portion 3 attached to each other by a locking element 25. In the shown embodiment, the locking element 25 is provided on the dispensing device 2 but in other embodiments it may be provided on the container portion 3. The individual portions 2, 3 are preferably made from plastics, e.g. by injection molding, but may also be made from glass, wood, or similar if a more sustainable dispensing unit 1 is desired.

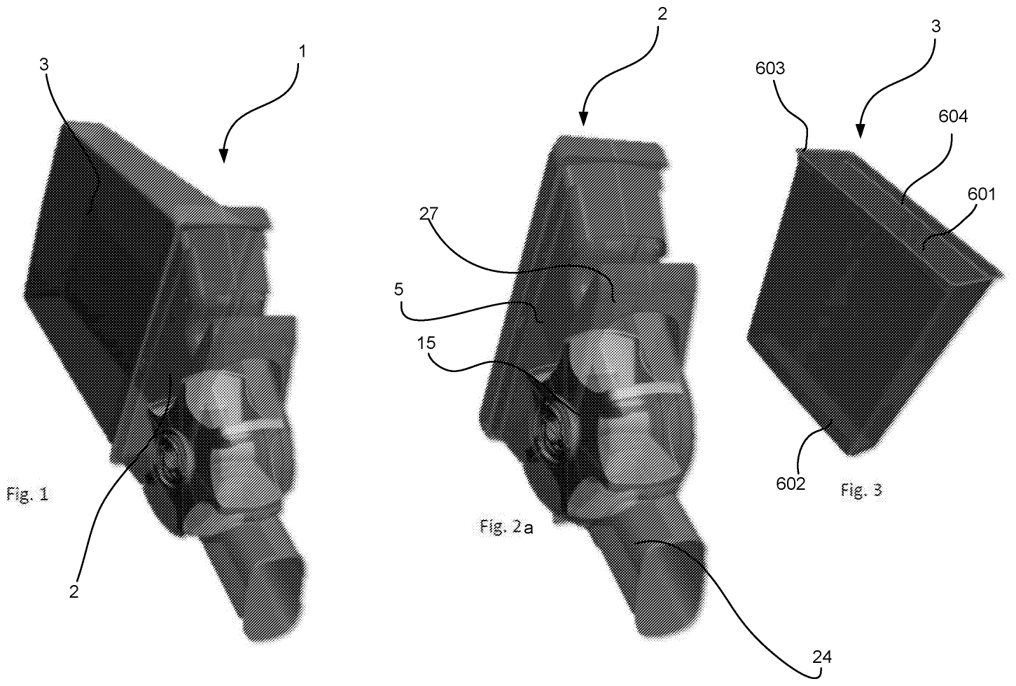

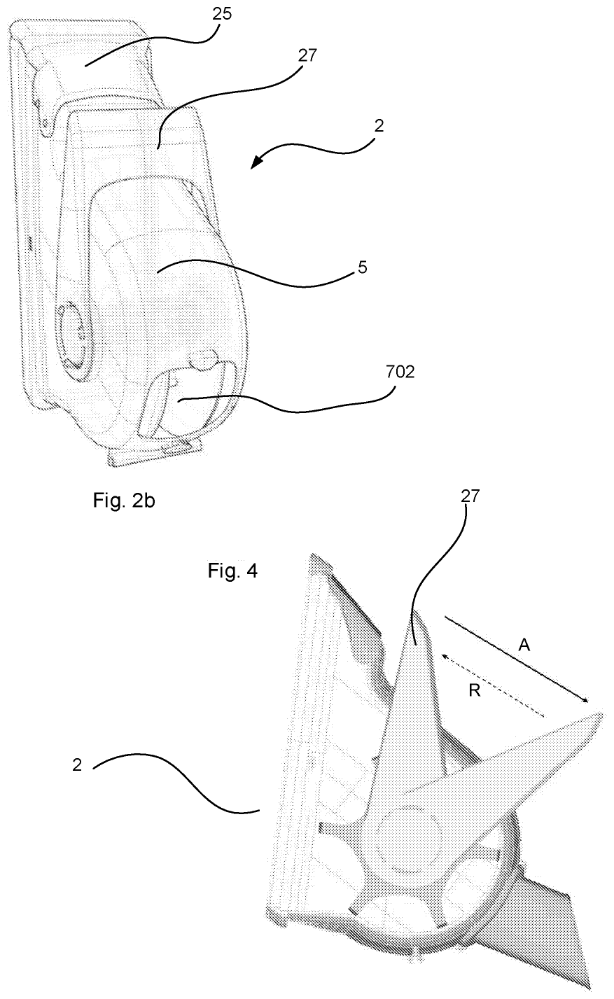

In FIG. 2 a dispensing device 2 of the dispensing unit 1 is shown. The dispensing device 2 comprises a forwarding device 15, a handle 27, and a spout 24. The handle 27 is connected to the forwarding device 15 so that movement of the handle 27 in an activation direction (A) by a user drives the forwarding device 15, whereby a predefined amount of foodstuff is dispensed to the user, such that the invention works as intended. The dispensing device 2 is adapted such that the foodstuff is led through a funnel 5 by means of the forwarding device 15. At an exit opening 702, the dispensing device 2 is provided with a spout 24 which ensures that the user can collect the dispensed amount of foodstuff.

FIG. 3 shows the container portion 3 which is adapted as a container capable of containing foodstuff, and which is open at one end 601 and closed in the opposite end 602 such that the foodstuff can be filled into and dispensed from the container portion 3. The open end 601 of the container portion 3 is provided with a circumferential edge 603 adapted to receive a sealing foil which may be adhered or welded onto the edge 603, so that the foodstuff is contained sealed in the container portion 3 until the container portion 3 is connected to the dispensing device 2. This allows the grocer to receive foodstuff in sealed container portions 3, from the manufacturer/storage, and connect the container portion 3 to a dispensing device 2 in the store, at which time the sealing is removed.

FIG. 4 shows the method by which the user via a handle 27 adapted to activate/drive the forwarding device 15 may dispense an amount of foodstuff from the dispensing unit 1. The handle 27 is connected to the forwarding device 15 such that the forwarding device 15 is activated when the handle 27 is moved in a first activation direction (A) and remains inactive when the handle 27 is moved in a reset direction (R) opposite to the activation direction (A). In the shown embodiment, the forwarding device 15 comprises an amount scoop 19 which defines six equally sized cavities. Each cavity may bring a predefined amount of foodstuff forward through the funnel 5 to the user.

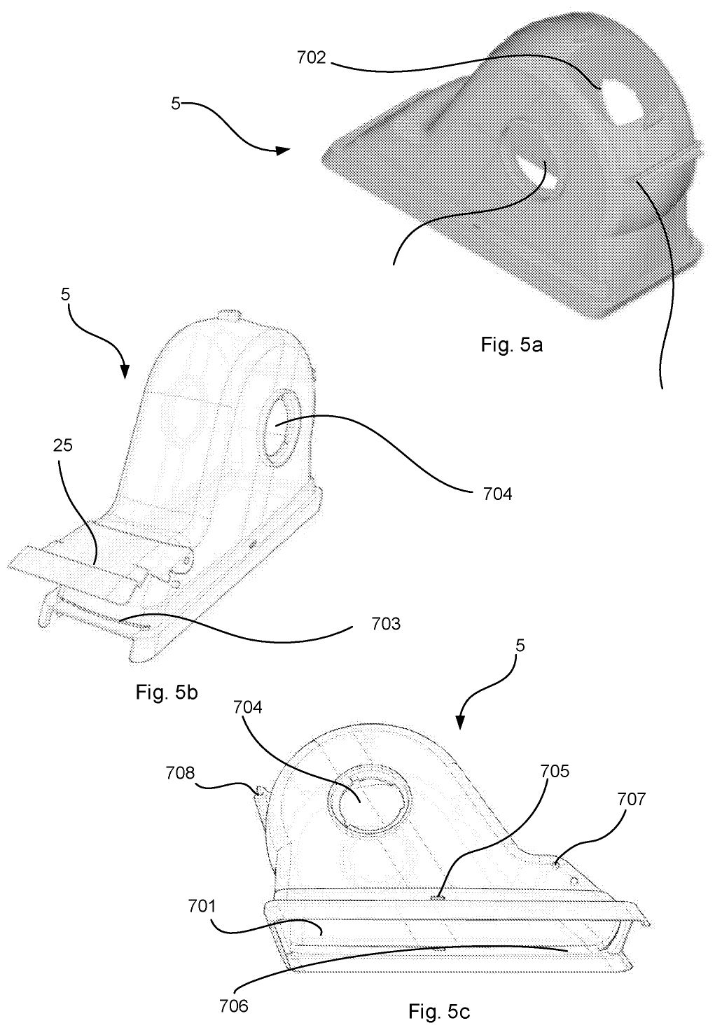

FIG. 5 shows the funnel 5 of the dispensing device 2. The funnel 5 is adapted with a larger opening 701 at one end and a smaller opening 702 at the other end, whereby dispensed foodstuff is led through the funnel 5. The funnel 5 is adapted such that the container portion 3 fits the larger opening of the funnel 5 so that the larger opening 701 of the funnel 5 encloses the open end 601 of the container portion 3. The funnel 5 further comprises the side openings 704 in which the forwarding device 15 is connected an rotatably mounted in the funnel 5. The funnel 5 comprises an empty area for a sealing element 31 adapted to seal the larger opening 701 of the funnel 5 such that foodstuff remaining in the funnel 5 may be contained in the dispensing device 2 when the container portion 3 is empty and needs to be replaced. In the shown embodiment, the funnel 5 is provided with two groves 706 extending along two sides of the larger opening 701, said grooves 706 being adapted to receive the sealing element 31 provided by a plane plate, so that the sealing element 31 can be easily attached and removed without difficulty. The funnel 5 is provided with a mounting element 708 for a rack 13, so that the dispensing unit 1 can be placed in a rack 13 without detaching during use.

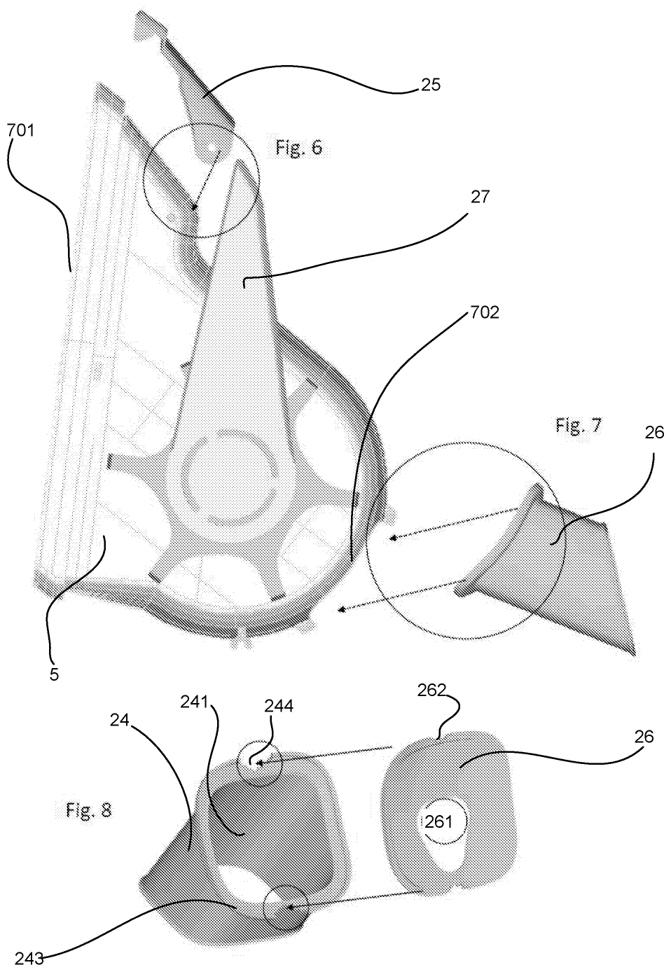

FIG. 6 shows a schematic drawing of an embodiment of the dispensing device 2. The dispensing device 2 further comprises a locking element 25 rotatably mounted on the funnel 5, which is adapted to engage the container portion 3 so that the dispensing device 2 and the container portion 3 may be releasably attached to each other.

FIG. 7 shows how a spout 24 may be attached on the funnel 5 at the smaller opening 702. The spout 24 is formed such that it fits the smaller opening 702 of the funnel 5 to cover the entire area of the smaller opening 702 of the funnel 5 wherefrom the foodstuff is dispensed.

FIG. 8 shows and dispense rate control element 26 according to the invention. The dispense rate control element 26 can be secured in the spout 24 and covers the open area 241, where the spout 24 is connected to the funnel 5. The dispense rate control element 26 is not used all the time, but only when the rate of dispensing of dispensed foodstuff needs to be limited. The dispensing unit 1 of the invention can be provided with multiple amount control elements 26, each having a different aperture 261 size, so that the rate by which the foodstuff is dispensed can be controlled by inserting the correct dispense rate control element 26.

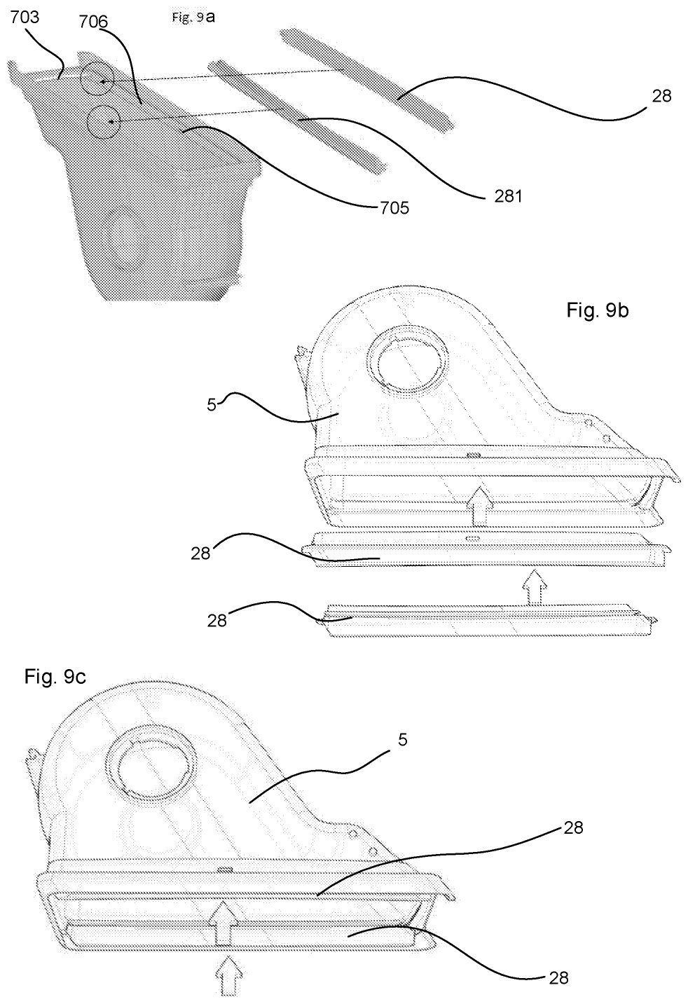

FIG. 9 shows how a container connection part 28 is fitted into the funnel 5. The funnel 5 is formed such that the container connection part 28 fits correctly along the sides of the funnel 5. The container connection part 28 is adapted as a one-way click connection which enables the attachment of the container portion 3 to the dispensing device 2.

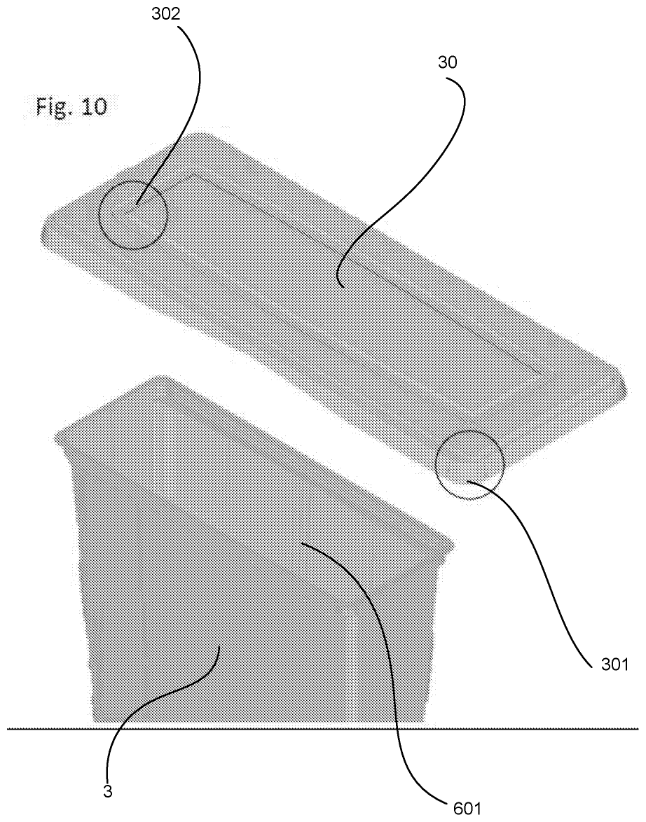

FIG. 10 shows a lid 30 and the method by which the lid 30 is fitted onto the container portion 3, so that the shelf time of the foodstuff is improved. One side of the lid 30 is formed such that a container portion 3 fits into a formed depression, whereby handling during transport from storage to store is improved. The lid 30 is provided with a tamper free evidence device 301 so that the user may be ensured the best possible hygiene.

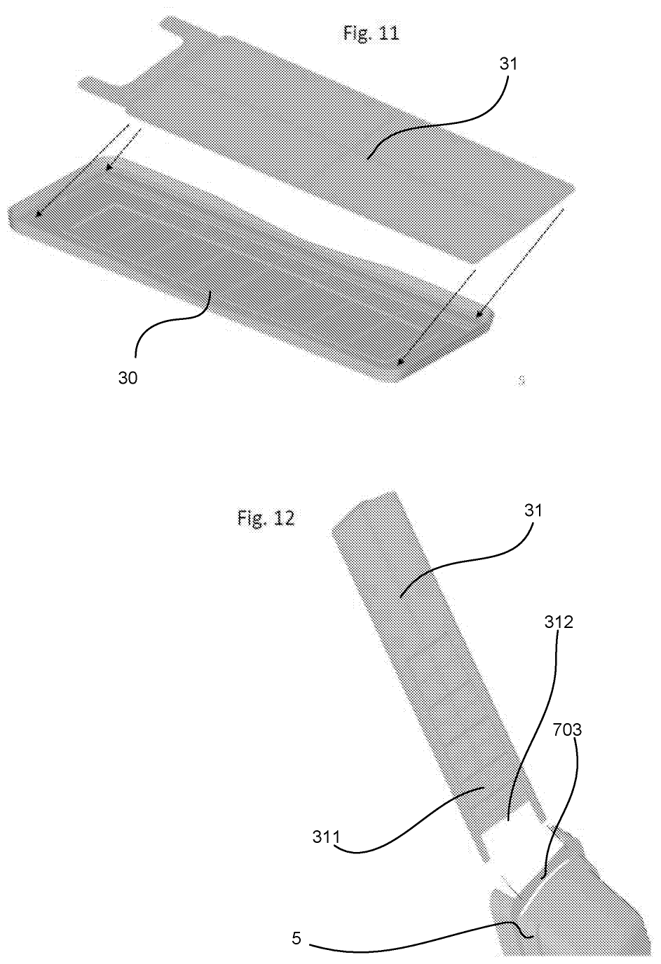

FIG. 11 shows the sealing element 31 which is adapted to fit into the underside of the lid 30, whereby the sealing element 31 is transported from production to the consumer inside the lid 30. The sealing element 31 is in some embodiments adapted for one-time use, so that risk of contagion may be reduced, however, in other embodiments, the lid 30 may be adapted to be reusable. The sealing element 31 is used in connection with the dispensing device 2 for the method of refilling a two-part dispensing unit 1 of the invention.

FIG. 12 shows how the sealing element 31 comprises an amount control arrangement 311 adapted to control an amount of the foodstuff which may enter or exit the larger opening 701 of the funnel 5 of the dispensing device 2. The amount control arrangement 311 functions by removal of sections from the amount control arrangement, whereby the area of an aperture 312 in the sealing element 31 can be adjusted, so that the amount of foodstuff filled into or removed from the dispensing device 2 can be controlled. In the shown embodiment, the sections of the amount control arrangement 311 are provided with cut-away sections in the sealing element 31. The amount control arrangement 311 is formed such that it fits the larger opening 701 of the funnel 5. The amount control arrangement 311 may be used, when it is necessary to control the amount of foodstuff entering the dispensing device 2 or exiting, if the dispensing device 2 is being emptied for remaining foodstuff. The amount control arrangement 311 is designed to be easy to insert and remove from the dispensing unit 1.

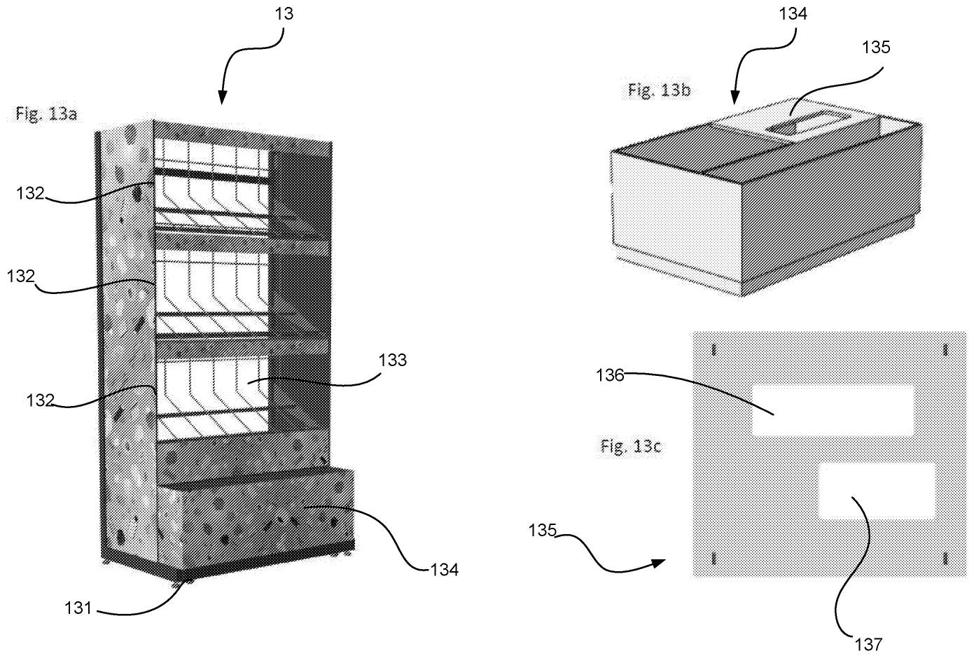

FIG. 13a-h show the apparatus and method used to refill the two-part dispensing unit 1 of the invention. FIG. 13a shows a rack 13 adapted to hold a number of two-part dispensing units 1 of the invention and to facilitate refilling of each single dispensing unit 1 in the store. The rack 13 comprises wheels 131 mounted on the underside of the rack 13 so that the rack 13 may be moved easily. The rack 13 has a shelf 132 with a number of retainment partitions 133 which each may retain a dispensing unit 1 in a use position in which the dispensing device 2 is angled correctly. The rack 13 further comprises a drawer 134 in which a refill holder is arranged 135.

FIG. 13b shows a drawer 134 with a refill holder 135 for holding a dispensing unit 1 during refilling. As can be seen in FIG. 13c, wherein the refill holder 135 is seen from above, the refill holder 135 has two slots 136, 137 adapted to hold the container portion 3 and the dispensing device 2, respectively.

FIGS. 13e-i show the steps of refilling a dispensing unit 1. In FIG. 13e, an empty or almost empty dispensing unit 1 is shown. The dispensing unit 1 is placed in the slot 137 of the refill holder 135 which is adapted to hold the dispensing device 2 so that remaining foodstuff is collected in the funnel 5 of the dispensing device 2. Meanwhile, a new full container portion 3 is placed in the slot 136 of the refill holder 135 which is adapted to hold a container portion 3.

In FIG. 13f the next step of the method for refilling a dispensing unit 1 is shown. The empty container portion 3 is released from the dispensing device 3 which now contain any remaining foodstuff. As is shown in FIG. 13g, the lid 30 is removed from the full container portion 3 and the sealing element 31 is removed from the lid 30. The sealing element 31 is hereafter transferred to the dispensing device 2 so that any remaining foodstuff is enclosed in the funnel 5.

FIG. 13h show how the dispensing device 2, which is now closed by the sealing element 31, can now be flipped around and mounted on the full container portion 3, after which the sealing element 31 is removed and the locking element 25, if the embodiment comprises this, is brought into engagement with the full container portion 2, so that the dispensing device 2 and the container portion 3 forms a refilled dispensing unit 1.

FIG. 13i shows how the now refilled dispensing unit 1 can be brought back into the use position in a rack 13.

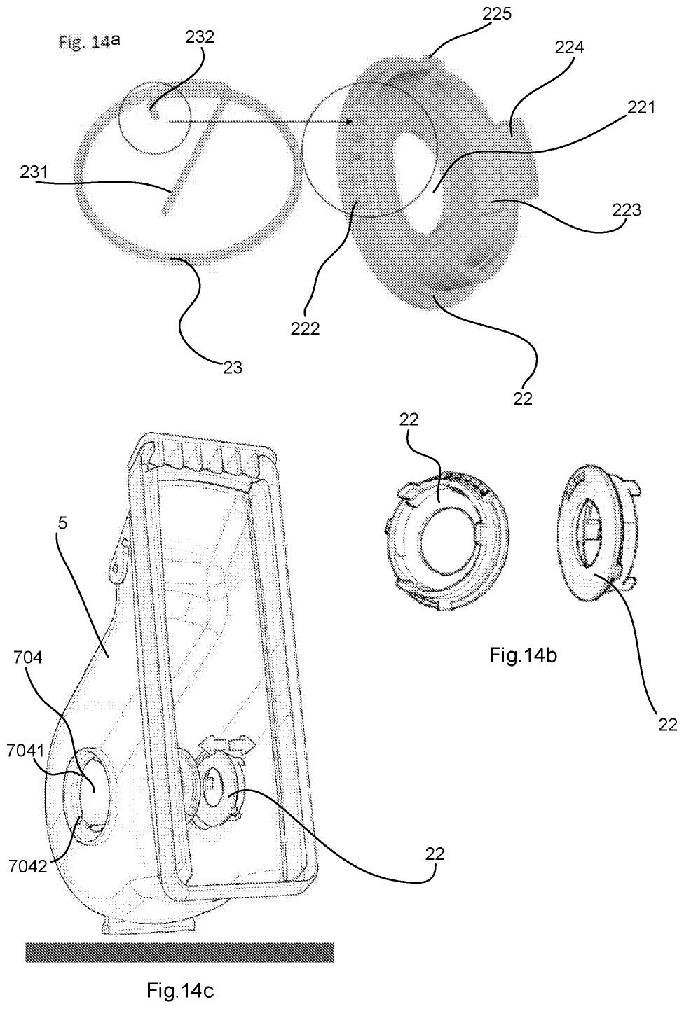

FIG. 14a shows a tensioning element 23 adapted to fit a tensioning element holder 22 with slots 222 formed to that purpose so that the amount of pre-tensioning of the tensioning element 23 can be adjusted by choosing a particular slot 222. This means that the force exerted by the tensioning element 23 on the handle 27 can be selectively adjusted. FIGS. 14b and c shows how the tensioning element holder 22 is press fitted into the side openings 704 of the funnel 5. The circumferential edge of the side openings is provided with notches 7041, 7042 adapted to receive corresponding protrusions 225 on the tensioning element holder 22, such that the tensioning element holders 22 is fitted non-rotatably into the side openings 704.

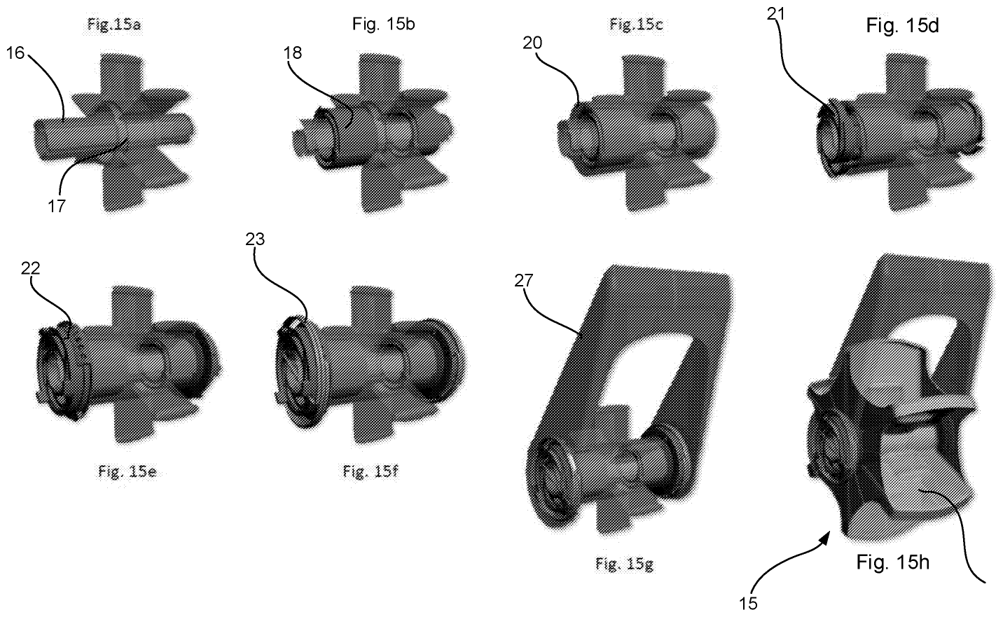

FIGS. 15a-h show the method of assembling the forwarding device 15. The forwarding device comprises an axle 16 placed in a cavity of a wheel 17. FIG. 15b shows a one-way drive part 18 which is pulled over the axle 16. FIG. 15c shows the placement of the one-way drive part house 20 placed outside the one-way drive part 18 and the axle 16 so the one-way drive part house 20 encloses the one-way drive part 18. In FIG. 15d the placement of a one-way stopping element 21 on the axel 16 is shown. FIG. 15e shows a tensioning element holder 22 placed on top of the one-way stopping element 21 such that the one-way stopping element 21 fits into the tensioning element holder 22 FIG. 15f shows a tensioning element 23 which is adapted to fit into slots 221 formed in the tensioning element holder 22 and around the tensioning element holder 22. FIG. 15g shows a handle 27 connected to the tensioning element 23 and the tensioning element holder 22. FIG. 15h shows a wheel 17 which is formed such that the amount scoop 19 fits onto a number of blades 171 formed on the wheel 17. These elements provide the forwarding device 15 with a one-way bearing connecting the handle 27 to the forwarding device 15 so that the forwarding device 15 rotates when the handle 27 is moved in the activation direction and stands still when the handle 27 is moved in the reset direction.

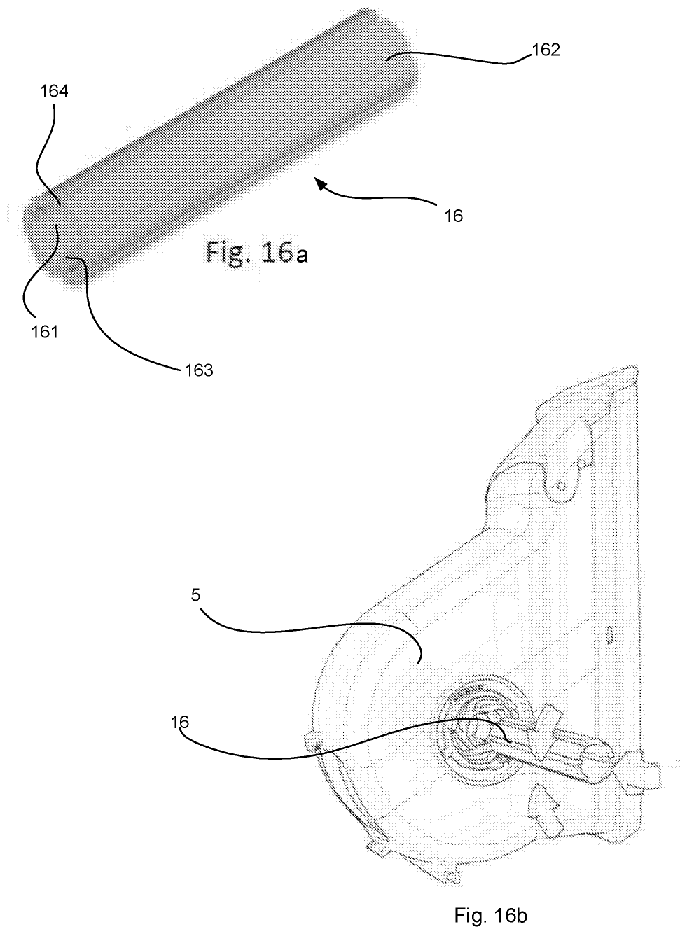

FIG. 16a shows an axle 16 of the forwarding device 15 the invention. The axle 16 is provided with depressions 162 formed such that the connected wheel 17 is moved by the axle 16. The shown axle 16 is hollow and open in both ends such that protrusions 271 on the handle 27 can be press fitted into the axle 16. The inner surface of the axle 16 is provided with a protrusion 163 extending radially inwards and extending along the length of the axle 16, said protrusion 163 being adapted to engage with corresponding notches 272 on the protrusions 271 of the handle 27 such that the handle 27 and the axle 26 are in secure engagement and rotate in unison, both when the handle 27 is moved in the activation direction A and the reset direction R. FIG. 16b shows how the axle 16 is inserted into the partially assembled forwarding device 15.

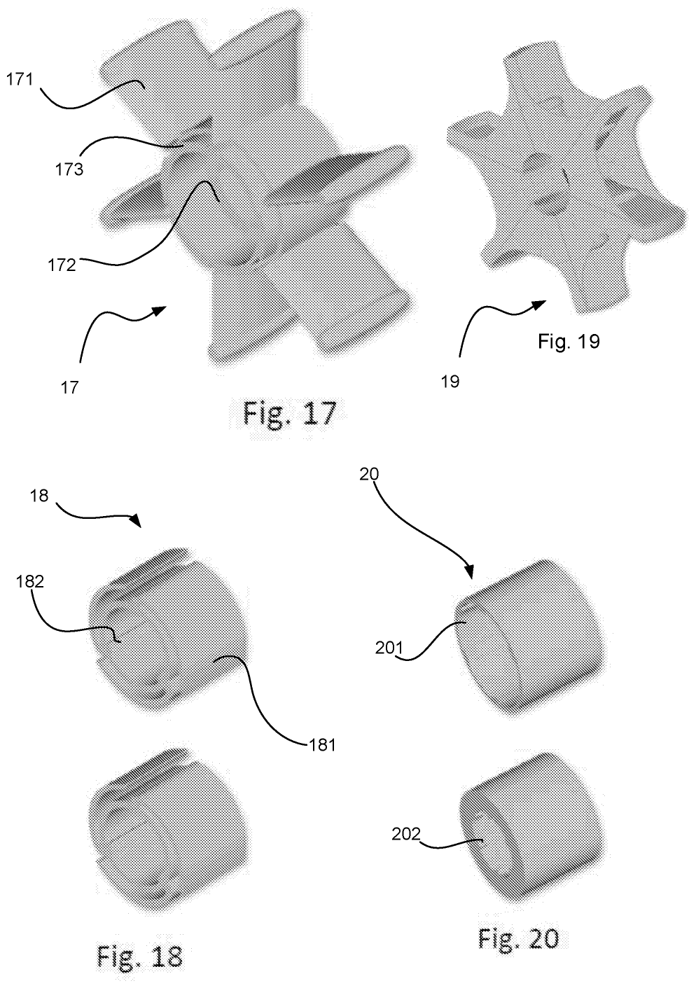

FIG. 17 shows the wheel 17 of the forwarding device 15. The wheel 17 is provided with a number of blades 171 adapted to engage the amount scoop 19 to drive it into rotation. The wheel 17 further comprises a central opening 172 adapted to accommodate the axle 16 without direct engagement between the axle and the central opening 172.

FIG. 18 shows the one-way drive part 18. The one-way drive part 18 is provided with a central opening 182 and a number of flexible wings 181 and is activated by movement of the handle 27 during use. The one-way drive part 18 has a hollow core formed such that it can accommodate the axle 16. To ensure engagement between the axle 16 and the one-way drive part 18, the hollow core of the one-way drive part 18 is provided with protrusions 182 adapted to engage the depressions 162 of the axle 16. The resulting engagement means that the axle 16 and the one-way drive part 18 move in unison, i.e. they both move when the handle 27 is moved in either the activation or reset directions.

FIG. 19 shows the amount scoop 19 which comprises a number of amount scoop elements 191 and is adapted to fit the blades 171 formed on the wheel 17. The purpose of the amount scoop 19 is to contain a predefined amount of foodstuff which is guided through the funnel 5. The amount scoop 19 can be shaped according to the shape and/or size of the foodstuff. The amount scoop 19 is activated by use of the forwarding device 15.

FIG. 20 shows the one-way drive part house 20 which is adapted to receive the one-way drive part 18 and is provided with grooves 202 that engages the spring devices 181 of the one-way drive part 18. The grooves 202 are also formed such, that when the forwarding device 15 is assembled, the engage corresponding protrusions 173 on the wheel 17, such that the one-way drive part house 20 and the wheel 17 move together.

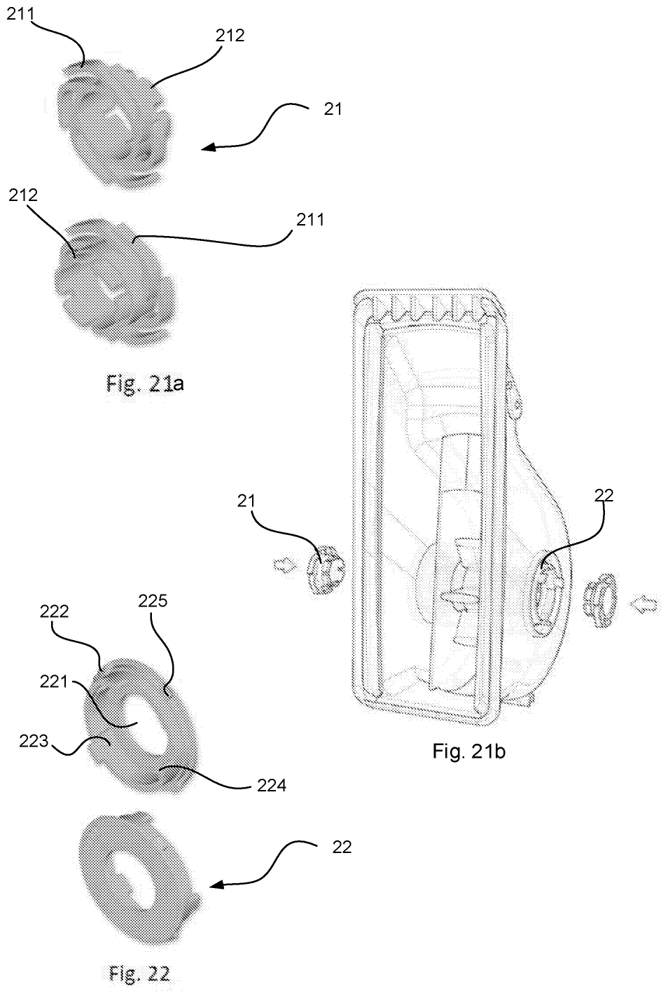

The flexible wings 181 of the one-way drive part 18 are formed such, that when the flexible wings 181 are engaged with the grooves 202 and the handle 27 is moved in the activation direction A, the flexible wings 181 will push the side walls which separate the grooves 202, whereby the one-way drive part 18 drives the one-way drive part house 20, and thereby the wheel 17, into rotation. On the other hand, when the handle 27 is moved in the reset direction R and the one-way drive part 18 rotates back with the axle 16, the flexible wings 181 allow the side walls which separate the grooves 202 to slide over the flexible wings 181, thus preventing the one-way drive part house 20 from rotating with the one-way drive part 18. FIG. 21a-b show the one-way stopping element 21. The one-way stopping element 21 comprises a number of engagement teeth 212 that are adapted to fit the central opening 221 of the tensioning element holder 22. The teeth 212 of the one-way stopping element 21 engages with corresponding protrusions 202 in the central opening of the one-way drive part house 20, whereby the one-way stopping element 21 rotates with the one-way drive part house 20.

FIG. 22 shows tensioning element holders 22 as also shown in FIGS. 14a-c. The tensioning element holders 22 forms a space which is adapted to accommodate the one-way stopping element 21. The space comprises a number of inclined ramps 223 arranged along the inner surface and adapted to engage corresponding flexible wings 211 on the one-way stopping element 21. The mutual interaction between the one-way stopping element 21 and the tensioning element holder 22 is the same as the one-way drive part 18 and the one-way drive part house 20. The inclined ramps 223 of the tensioning element holder 22 allows the flexible wings 211 to slide over the inclined ramps 223 by pressing down the flexible wings 211 when the one-way stopping element 21 rotates during activation. When the handle 27 is moved in the reset direction R, the flexible wings 211 will abut the edge of the inclined ramps 223, thus ensuring that the one-way drive part house 20 and the wheel remain static during resetting of the handle 27.

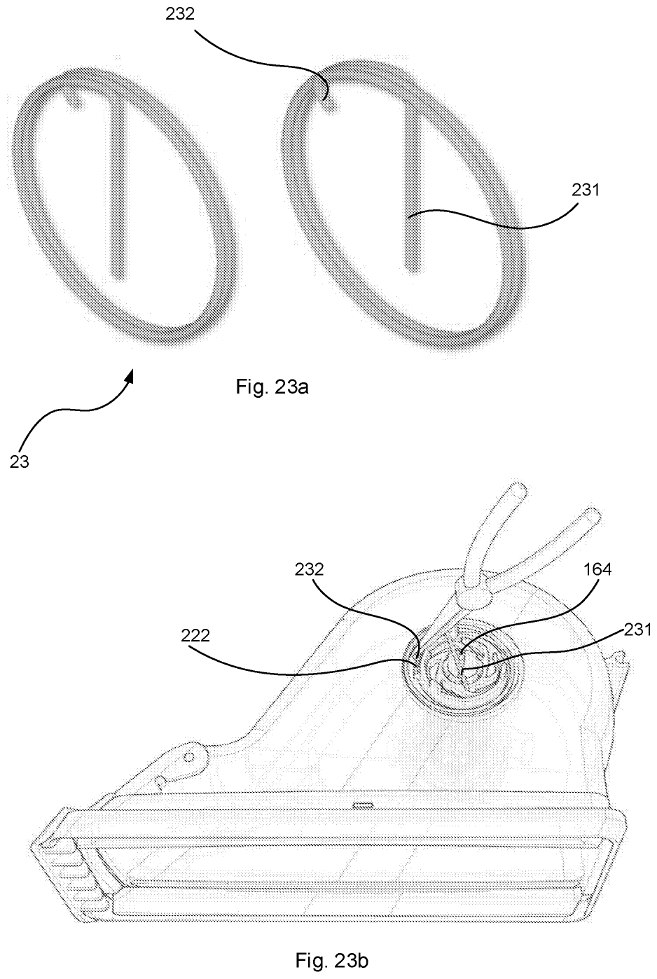

FIG. 23a shows the tensioning element 23. The tensioning element 23 comprises a spring which engages with the slots 221 in the tensioning element holder 22 as explained above for FIG. 14. The tensioning element 23 further comprises a pin 231 which engages with the axle 16, such that the tensioning element 23 upon activation of the forwarding device 15 is tensioned and returns to a resting position when the forwarding device 15 is reset. FIG. 23b shows how the tensioning element 23 is connected the axle 16 and to the tensioning element holder 22. In the shown embodiment, the tensioning element 23 is provided by a spiral spring, wherein one end of the spring forms a pin 231 adapted to engage the axle 16 and the other end forms another pin 232 adapted to engage one of the number of slots 222 in the tension element holder 22. As the tension element 22 holder remains static while the axle is rotated during activation, by movement of the handle 27 in the activation direction A that is, the tensioning element 22 is tensioned when the forwarding device is activated, whereby the tensioning element 22 will urge the axle 16, and thereby the handle 27, in the reset direction.

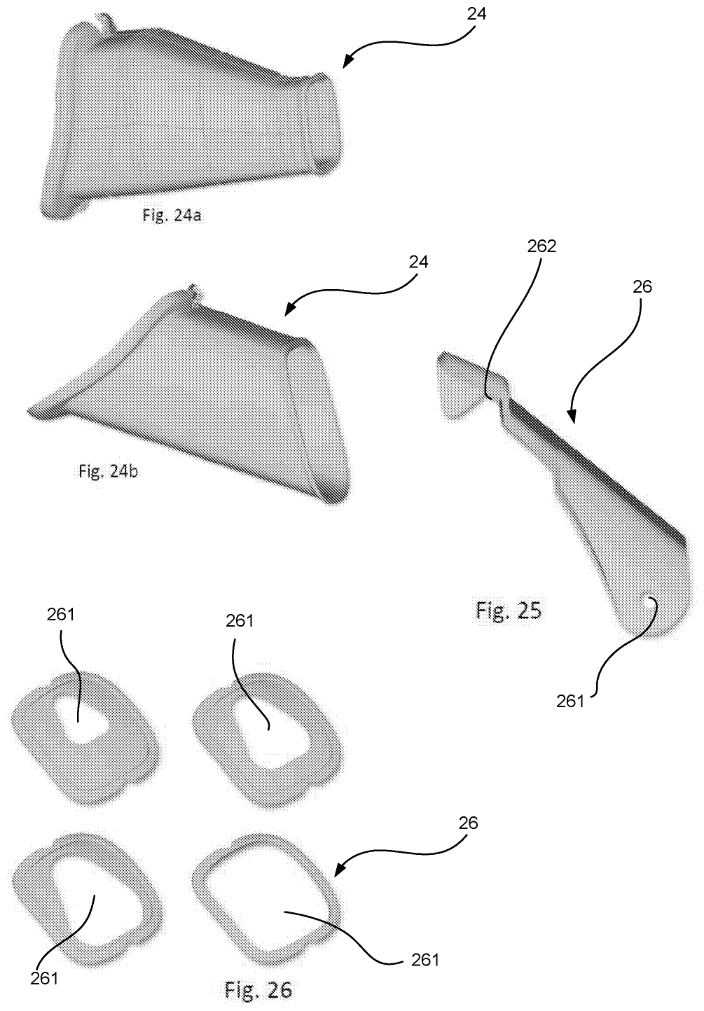

FIGS. 24a-b show different embodiments of the spout 24 which functions as a further funnel so that the foodstuff is guided through one opening 241 to another opening 242. Thereby, the spout 24 establishes a connection to the funnel 5 by means of a snap-lock function. The spout is adapted to be able to hold a dispense rate control element 26 which can fit into a depression of the spout 24.

FIG. 25 shows a locking element 25 of the invention. The locking element 25 comprises a grabbing part 251 which connects the funnel 5 to the container portion 3. The locking element 25 has two side openings 252 which allows the locking element 25 to be connected to the funnel 5, while being rotatable in two directions, a locking direction and a release direction. The locking element 25 is adapted such that when moved in the locking direction, in which the funnel 5 and the container portion 3 is attached, the locking element 25 covers the opening in the funnel 5 used for the sealing element 31 and the amount control element 32, whereby impurities is kept out of the dispensing unit 1.

FIGS. 26a-d show embodiments of the dispense rate control element 26. The dispense rate control element 26 is provided with a central aperture 261, whereby a respective dispense rate control element 26 may be selected according to a desired dispensing rate. The dispense rate control element 26 is formed such that it fits into the depression of the spout 24. Thereby, the dispense rate control element may easily and quickly be changed by removal of the spout 24, replacement of the dispense rate control element 26, and subsequent re-attachment of the spout 24 to the funnel 5.

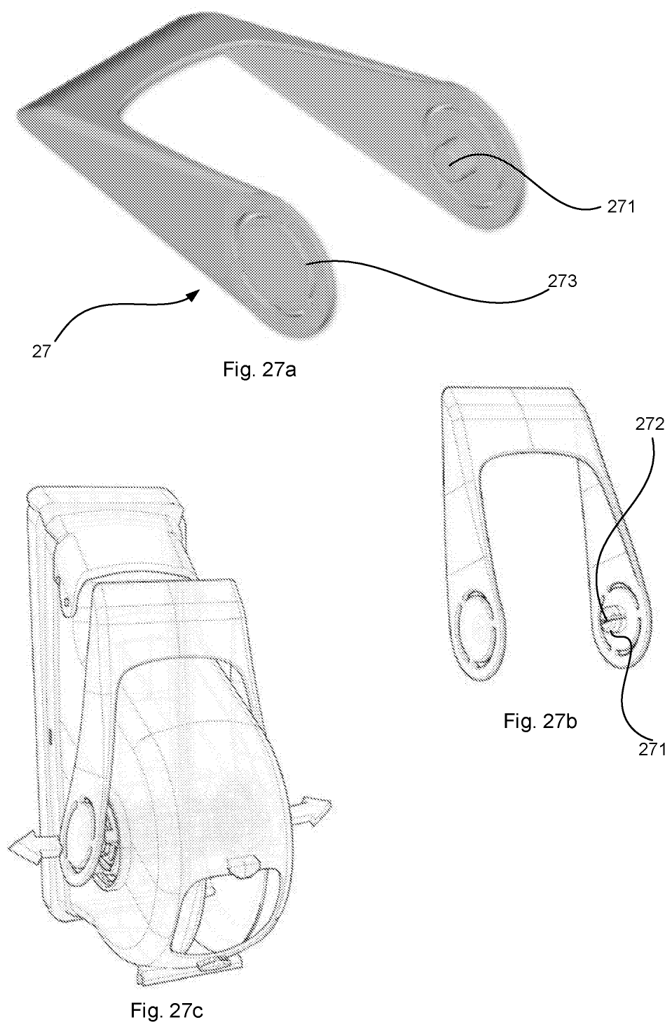

FIG. 27 shows a handle 27 of the dispensing unit 1 of the invention. The handle 27 comprises a device which is connectable to the tensioning element 23 and the one-way drive part house 20, to thereby allow two-way rotation in the activation direction and the reset direction. The handle 27 provided with a number of side openings 271 which through engagement with the one-way drive part house 20 limits the angular range of motion.

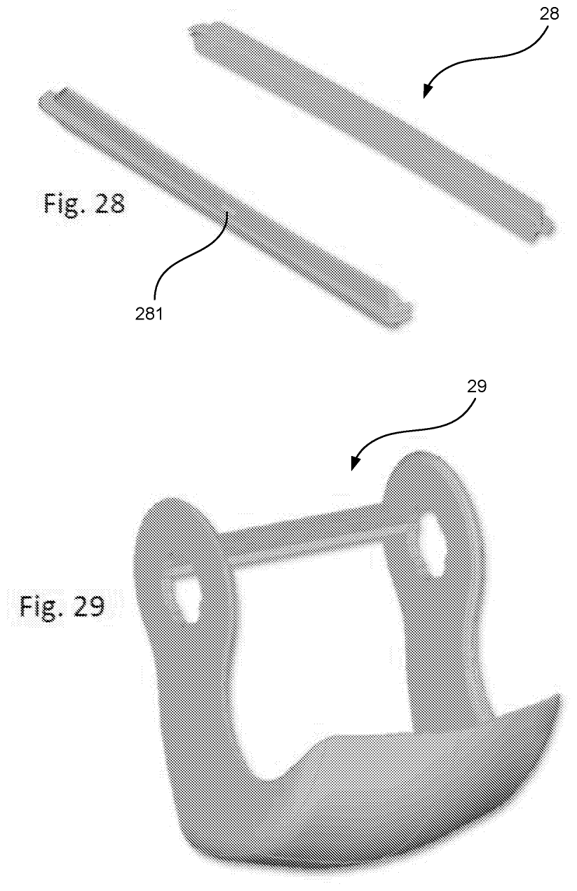

FIG. 28 shows the container connection part 28 which is adapted to fit into depressions of the funnel 5 by slight pressure, after which a snap-lock on the side of the container portion 3 is connected to the funnel 5. The connection between the container connection part 28 provides a cavity in which the container portion 3 fits.

FIG. 29 shows a rotating scoop element 29 adapted to be able to replace the amount scoop 19 according to the foodstuff. The rotating scoop element 29 is formed such that the axle 16 fits through side openings 291 in the scoop element 29. The rotating scoop element 29 can be activated through the connection between the axle 16, the tensioning element holder 22, the tensioning element 23, and the handle 27. The rotating scoop element 29 is adapted such that when it is activated, by movement of the handle 27 in the activation direction, the foodstuff is guided through the funnel 5 and out through the spout 24, and when the scoop element 29 is reset, by movement of the handle 27 in the reset direction, the smaller opening 702 of the funnel 5 is covered, whereby remaining foodstuff is contained in the funnel 5.

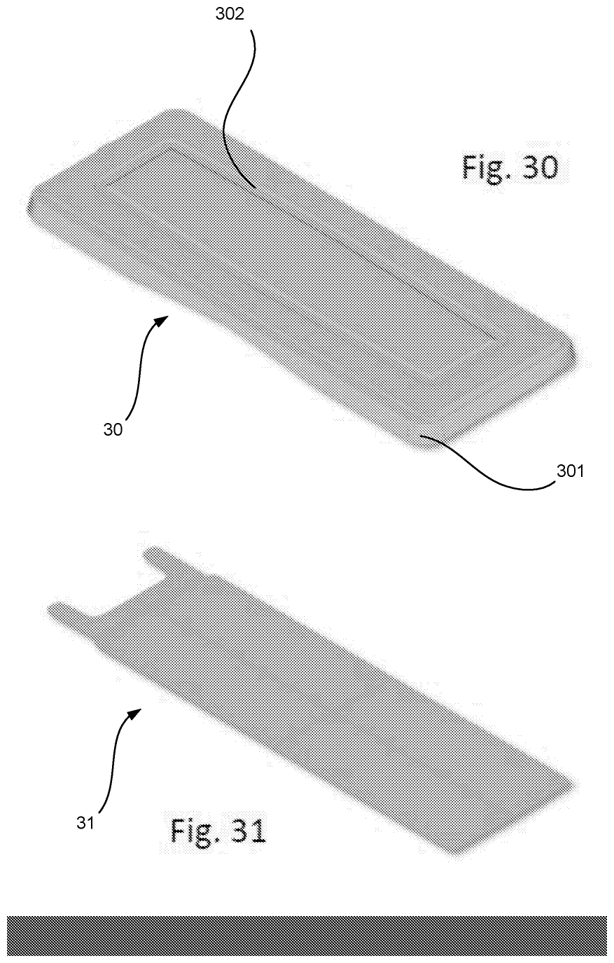

FIG. 30 shows an embodiment of a lid 30 of the invention. The lid 30 fits onto the container portion 3. The upper side 301 of the lid 30 is shaped such that another container portion 3 of the invention fits into a depression 302 formed in the lid 30, when the other container portion 3 is placed with its closed bottom into the depression 302. The lid 30 is provided with a tamper free evidence device which may be broken upon use.

FIG. 31 shows a sealing element 31 of the invention. The sealing element 31 is formed such that it fits into the lower side 303 of the lid 30 as shown in FIG. 11. The sealing element 31 is formed such that it can be inserted into an opening 703 in the funnel 5, as seen in FIG. 12, and be removed from the same opening 703.

1. A dispensing device for a two-part dispensing unit for dispensing foodstuff, said dispensing device comprising:
a funnel comprising a first opening adapted to face a container portion of the two-part dispensing unit and a second opening adapted to dispense the foodstuff,
a forwarding device adapted to lead an amount of foodstuff from the first opening to the second opening, and
a handle connected to the forwarding device and adapted to activate the forwarding device,
wherein the handle is connected to the forwarding device such that the forwarding device is activated when the handle is moved in a first activation direction and the forwarding device is not activated when the handle is moved in an opposite reset direction.

2. The dispensing device of claim 1, wherein the dispensing device further comprises a one-way bearing which connects the handle to the forwarding device, and wherein the forwarding device rotates when the handle is moved in the activation direction and remains still when the handle is moved in the opposite reset direction.

3. The dispensing device of claim 1, wherein the dispensing unit further comprises a tensioning element which urges the handle towards the opposite reset direction.

4. The dispensing device of claim 3, wherein the tensioning element is tensioned by movement of the handle in the activation direction.

5. The dispensing device of claim 3, wherein the tensioning element can be pre-tensioned to adjust the force by which the tensioning element urges the handle towards the opposite reset direction.

6. The dispensing device of claim 1, wherein the forwarding device comprises a wheel with a number of equally sized cavities adapted to lead a predetermined amount of foodstuff from the first opening to the second opening.

7. The dispensing device of claim 1 further comprising a sealing element adapted to cover the first opening.

8. The dispensing device of claim 7, wherein the funnel comprises two groves extending along respective sides of the first opening, said grooves being adapted to receive the sealing element.

9. A two-part dispensing unit for dispensing foodstuff, said dispensing unit comprising:
a container portion adapted to contain the foodstuff; and
a dispensing device comprising:
a funnel with a first opening adapted to face a container portion of the two-part dispensing unit and a second opening adapted to dispense the foodstuff,
a forwarding device adapted to lead an amount of foodstuff from the first opening to the second opening, and
a handle connected to the forwarding device and adapted to activate the forwarding device, wherein the handle is connected to the forwarding device such that the forwarding device is activated when the handle is moved in a first activation direction and the forwarding device is not activated when the handle is moved in an opposite reset direction.

10. A method comprising dispensing foodstuff via a dispensing device, wherein the dispensing device comprises:
a funnel with a first opening adapted to face a container portion of the two-part dispensing unit and a second opening adapted to dispense the foodstuff,
a forwarding device adapted to lead an amount of foodstuff from the first opening to the second opening, and
a handle connected to the forwarding device and adapted to activate the forwarding device, wherein the handle is connected to the forwarding device such that the forwarding device is activated when the handle is moved in a first activation direction and the forwarding device is not activated when the handle is moved in an opposite reset direction.

11. A method for replacing or refilling a container portion of a two-part dispensing unit, wherein the method comprises:
placing the two-part dispensing unit vertically with the dispensing device facing downwards;
separating the container portion from the dispensing device;
sealing the first opening of the dispensing device with a sealing element;
refilling the container portion or replacing the container portion with another container portion;
mounting the dispensing device on one of the refilled container portion or the other container portion; and
removing the sealing element from the dispensing device.

12. The method of claim 11, wherein the two-part dispensing unit comprises:
a container portion adapted to contain the foodstuff; and
a dispensing device comprising:
a funnel with a first opening adapted to face a container portion of the two-part dispensing unit and a second opening adapted to dispense the foodstuff,
a forwarding device adapted to lead an amount of foodstuff from the first opening to the
